(19) United States
(12) Patent Application Publication
(10) Pub. No.: US 2020/0250716 A1
(43) Pub. Date: Aug. 6, 2020

(54) COMPUTER-PROJECTED CONFIDENCE INDICIA

(71) Applicant: FAIR ISAAC CORPORATION, Roseville, MN (US)

(72) Inventor: James Laura, San Rafael, CA (US)

(21) Appl. No.: 16/265,944

(22) Filed: Feb. 1, 2019

(51) Int. Cl. G06Q 30/02; G06N 5/04

(52) U.S. Cl. CPC G06Q 30/0282; G06N 20/00; G06N 5/048

(57) ABSTRACT

A computer-implemented method and system for generating a confidence indicia. The method may comprise obtaining information associated with one or more items available for selection via user interaction with a user interface of a computing device operating in a computing environment. The computing environment may provide access to resources that store information about at least one characteristic of the one or more items, wherein the at least one characteristic is measurable. A trust level may be determined for a characteristic of a first item based on one or more computerized processes that evaluate values associated with the at least one characteristic across a set of values provided by users who considered at least one of the first item or a second item. The first item and the second item are associable according to a common category.

### COPYRIGHT & TRADEMARK NOTICES

A portion of the disclosure of this patent document may contain material, which is subject to copyright protection. The owner has no objection to facsimile reproduction by any one of the patent document or the patent disclosure, as it appears in the Patent and Trademark Office patent file or records, but reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter generally relates to improvements in a computing technology associated with enhancing confidence in selecting an item and, more particularly, to computing systems and methods that may provide or project one or more indicia of confidence or trust level in association with one or more items being presented for selection from among a plurality of other items.

### BACKGROUND

Computer-implemented technologies are available that provide users with tools and interfaces that allow a user to research an item before making a selection. For example, in addition to the general item description and price, some providers offer ratings or reviews submitted by prior viewers. Some providers may also include similar items to the one being reviewed, or make suggestions for other items or services that complement a selected item.

Unfortunately, the conventional computing tools and interfaces mentioned above are only helpful in a limited manner. That is, using these tools or interfaces, a user may be able to make a seemingly informed decision at the point of selection or point of sale. Disadvantageously, however, often a user cannot fully rely on the provided information, because some of the ratings and reviews may be deceitful, old or generally unreliable.

As one example, the total or average rating of an item may be highly influenced by fake or malicious inputs provided by unscrupulous reviewers. As such, many of the provided ratings and reviews may not only have limited accuracy, some may also include information that is completely wrong, false and untrustworthy. Without having a measure of confidence in the authenticity or accuracy of the provided information, the suggested ratings can be worthless.

Confidence in ratings is especially very important when a user is trying to select an item from a large group of similar items because a user cannot possibly calculate the veracity of each review or rating. Accordingly, it would be desirable to improve the currently available rating technologies by providing a measure of confidence for the published reviews or ratings, which would also foster higher user satisfaction, lower number of returns and a general increase in provider profitability.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, a computer-implemented method and system for generating a confidence indicia is provided. The method may comprise obtaining information associated with one or more items available for selection via user interaction with a user interface of a computing device operating in a computing environment. The computing environment may provide access to resources that store information about at least one characteristic of the one or more items, wherein the at least one characteristic is measurable.

A trust level may be determined for a characteristic of a first item based on one or more computerized processes that evaluate values associated with the at least one characteristic across a set of values provided by users who considered at least one of the first item or a second item. The first item and the second item are associable according to a common category. A sensory output may be conspicuously presented in the user interface.

The sensory output represents the trust level for the at least one characteristic of the first item in a manner that distinguishes the first item from other items that are associable with the first item in the common category, to advantageously assist a user with selecting the first item. The first item may be selectable over the second item, in response to a user determining that the trust level associated with the at least one characteristic of the first item is more desirable.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates an exemplary operating environment in accordance with one or more embodiments, wherein indicia of confidence may be calculated or presented to a user in association with one or more items being selected from among a plurality of other items.

FIG. 2 is an exemplary flow diagram of a method of calculating or presenting a trust level for a target item, in accordance with one embodiment.

FIG. 3 is an exemplary flow diagram of a method of grouping or filtering one or more items based on a confidence threshold, in accordance with one embodiment.

FIG. 4 is a visual illustration of an example graphical user interface, which when implemented in a computing environment provides information about various ratings calculated for a target item, in accordance with one or more embodiments.

Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

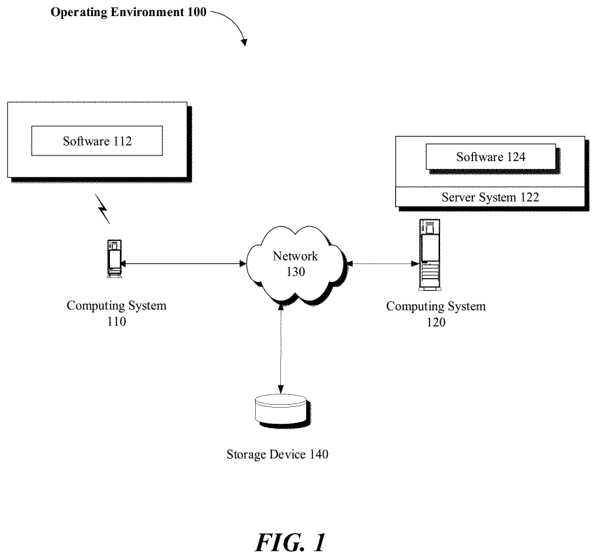

Referring to FIG. 1, an example operating environment 100 is illustrated in which a computing system 110 may be used by a user to interact with software 112 being executed on computing system 110. The computing system 110 may be a general computer, a handheld mobile device (e.g., a smart phone), a tablet (e.g., an Apple iPad®), or other communication capable computing device. Software 112 may be a web browser, a dedicated app or other type of software application running either fully or partially on computing system 110.

Computing system 110 may communicate over a network 130 to access data stored on storage device 140 or to access services provided by a computing system 120. Depending on implementation, storage device 140 may be local to, remote to, or embedded in one or more of computing systems 110 or 120. A server system 122 may be configured on computing system 120 to service one or more requests submitted by computing system 110 or software 112 (e.g., client systems) via network 130. Network 130 may be implemented over a local or wide area network (e.g., the Internet).

Computing system 120 and server system 122 may be implemented over a centralized or distributed (e.g., cloud-based) computing environment as dedicated resources or may be configured as virtual machines that define shared processing and storage resources. Execution, implementation or instantiation of software 124 over server system 122 may also define a special purpose machine that provides remotely situated client systems, such as computing system 110 or software 112, with access to a variety of data and services as provided below.

In accordance with one or more implementations, the provided services by the special purpose machine or software 124 may include providing a user, using computing system 110 or software 112, with access to information for selecting one or more items from a plurality of items. The selection may be for the purpose of obtaining information for purchase or otherwise. For example, a user may be provided with options to select or purchase an item from multiple vendors, or a vendor may provide a user with options to select from one or more items or products of similar type and category.

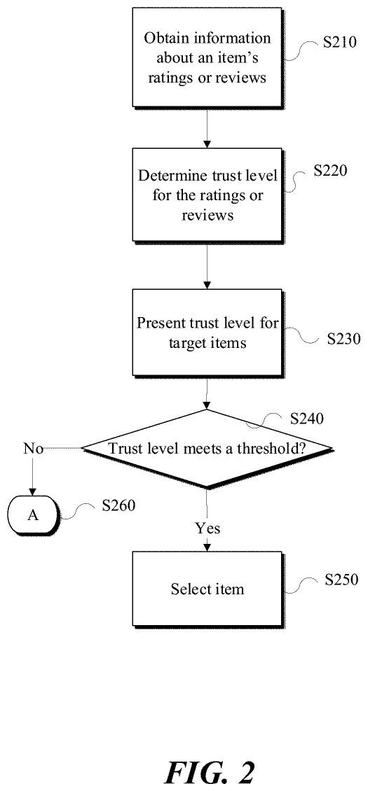

Referring to FIGS. 1 and 2, a computer-implemented method for providing a level of confidence in selecting the most suitable item from among one or more items is provided. The method may comprise a user interacting with a user interface of computing system 110 to launch an application or software 112. Software 112 may be a browser or app that provides the user with a search capability or with access to a resource that offers a wide variety of services, including providing options for selections from a plurality of items (e.g., products for purchase or services for subscription as offered by a vendor or service provider).

Referring to FIG. 2, computing system 120 or software 124 may be configured to provide a user with services that enhance user experience when selecting an item offered by a vendor or service provider. The provided services may include obtaining information associated with one or more items made available for selection (e.g., via user interaction with a graphical user interface of a computing system 110)—the obtained information may be about at least one characteristic of the one or more items, such as ratings or reviews that are measurable according to some standard (S210). According to one aspect, a ranking may be provided for a product or service based on aggregating values calculated from user reviews or user ratings.

Based on data or information obtained from prior ratings or reviews, a special purpose machine or system (e.g., software 124) may determine a trust level or confidence indicia for the user ratings or reviews or any other quality or characteristic associated with a target item (S220). For example, as provided in further detail below, one or more computerized processes may be used to evaluate reviews or ratings provided by users who previously selected, purchased or considered an item, to determine a level of trust for the posted ratings or reviews. It is noteworthy that, as used herein, terminology referring to level of trust, confidence indicia, trustworthiness and the like is meant to suggest, without limitation, a score or measurable level of certainty associated with a rating or review or other characteristic associated with a target item provided for selection.

When a trust level is calculated, an indication of the trust level (e.g., a confidence indicia) is conspicuously presented to the user in the form of, for example, a graphical or sensory output (S230). Among other implementations, a graphical object may be presented in form of at least one of a numeric value, mnemonic, a color-indication, a visual chart, a graph or other visual feature that provides a user with a comparative result that inspires a confidence level in the user as to whether to select or purchase the target item over another item. Regardless of the form of presentation, the trust level may be calculated for a particular rating or review, a collection of ratings or a collection of reviews, or based on an evaluation of some or a combination of the ratings or reviews, depending on implementation.

In accordance with some aspects, the trust level helps distinguish a target item from other items that are associable with the target item in a common category. This distinction, advantageously, assists a user with selecting the first item. By way of example, the trust level may indicate that the sum of all ratings for an item taken together has a 60% trust level, or that the sum of selected reviews provided for the same item has an 80% trust level. In another scenario, trust level associated with an item selected by a user may indicate that the sum of some of the ratings and reviews taken together has a 70% trust level, for example. In the last example scenario, if a target item has, for example, a rating of 10 out of 10, then a user viewing the trust indicator or trust level at 70% may understand that approximately 70% of the selected ratings and reviews are trustworthy.

In certain implementations, the trust level may be indicated by confidence indicia (e.g., one or more numeric values) so that it is easier for a user to understand the trustworthiness of ratings or reviews or other rankings associated with a target item. For example, a score of 100 may indicate a highest level of trustworthiness, and a score of zero may indicate a lowest level of trustworthiness, with values in between respectively corresponding to higher or lower trustworthiness levels. Nevertheless, regardless of the exact mechanics employed, once the trust level meets a threshold (S240), then the user may select the target item (S250). In accordance with one or more aspects, if desirable, the system may be implemented to automatically make a selection for the user when a certain threshold trust level is met, or otherwise terminate the process (S260).

It is noteworthy that the embodiments and implementations provided herein with respect to ratings or reviews are disclosed, by way of example, to provide for a meaningful understanding of the disclosed subject matter and should not be construed as limiting the scope of this disclosure to such example features or implementations. By way of illustration, the methodology disclosed herein may be utilized and be applicable in any environment in which rankings associated with a target item or service are provided, in a manner such that the veracity of such rankings may be suspect (e.g., public rankings sites, social media, etc.). Employing the techniques and processes disclosed herein help improve over rating technologies that simply provide rankings and reviews, without any indication of confidence, so that a user is enabled to make a more informed decision at the point of selection or point of sale, for example.

Accordingly, to provide a level of trust in information published or shared about a target item (e.g., a service or product that is viewed, selected or considered for selection), bodies of data associated with the reviews of the item are analyzed to determine different factors that may be considered in order to determine whether a provided review is authentic, relevant or trustworthy. Examples of factors and data that may be taken into consideration for a target item may include, without limitation:
the number of reviews or ratings for an item or items in the same category,
the number of verified selections or purchases (i.e., whether there is proof the reviewer actually selected or purchased the item under review),
length of time the item has been available or on the market (e.g., an item with a high longevity on the market may or should have relatively more verifiable ratings in comparison to an item that is new or remains untested—many reviewers change their reviews after having had the item or have used the item for a longer duration of time),
statistical distribution of different ratings across the provided reviews (i.e., the frequency of occurrence of a particular rating chosen from a set of ratings),
relative weight associated with ratings or number of reviews for items of similar nature or products belonging to a same or similar category as the target item,
geographic location from which a review was instantiated or provided (e.g., by way of examining geo-location identifiers such as Internet Protocol address or device identifier (e.g., MAC address, UDI, etc.) associated with a device, email address, phone number, or other unique identifier or data usable to determine at least an approximate location of the reviewer—this data may be used to verify the authenticity of a review posted, for example, by confirming that the review was posted by a particular user or device and also as verified against other data such as source of funding (e.g., if the item was selected or purchased) to confirm a confidence level for the posted review), and
linguistic pattern authentication of the rating or review (e.g., using techniques for determining the native origins of speech used in a written review to, for example, determine if a review is unauthentic—i.e., to determine whether a review was written by a bot (robot) or a fake reviewer who was writing the review to unjustly influence the item's rating).

By way of example, using one or a combination of the above factors, reviews or ratings submitted for a target item or a group of target items may be scrutinized as to veracity and authenticity. If the result of the analysis suggests that a majority of the ratings or reviews are unauthentic, for example, an initial or prior confidence indicia associated with the target item may be adjusted to reflect the lack of confidence in the reviews or ratings. Similarly, if an analysis of the factors indicate a high degree of reliability in the reviews or ratings, then the confidence indicia may be adjusted to indicate a high level of confidence in the posted reviews or rating. As such, the confidence indicia may be adjusted overtime or in real-time as new ratings and reviews are posted for an item.

In one or more embodiments, the trust level for a rating or review posted for an item may be identified by a numeric score that indicates the likely validity for the item's total rating. The score may be presented as a measurable and easily comprehensible identifier for a human user to indicate the likelihood that the posted rating is a true reflection of the item's ranking or quality. Thus, such score may be used either independently or in a mathematical model to adjust or complement other confidence indicia associated with an item.

As provided herein, and without limitation, different means may be employed to provide indications of higher or lower levels of confidence in ratings or reviews posted for an item. For example, in one or more embodiments, an initially determined rating value may be increased or decreased to indicate a higher or lower level of confidence. In other aspects, a color-coding scheme may be employed, or the font or other attributes associated with a rating may be altered or refined to help alert a customer or consumer of the state of or a change in the confidence level for the item, for example.

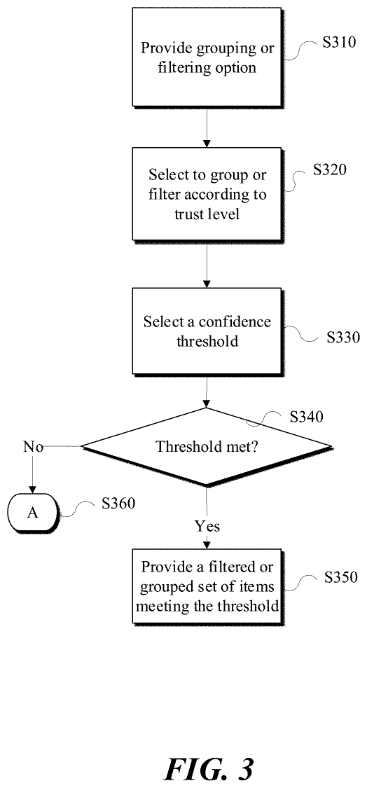

Referring to FIG. 3, once a confidence level for ratings or reviews is established or calculated for a target item, the confidence level and the related information may be utilized as a mechanism to help group or filter certain items for review or user attention, for example, by providing a grouping or filtering option to a user (S310), such that a user may select to group or filter a target item according to trust level (S320). In one implementation, a user may be enabled to filter based on a particular size, color and price range, for example, and in addition request for the filtered results to meet a rating that satisfies a confidence level in a selected range or threshold (S330).

In one implementation, a user may request that ratings or reviews that do not meet a certain confidence level not to be taken into consideration for the purpose of rating, or not to be displayed for viewing, for example. Nevertheless, regardless of how a threshold or a range for the confidence level is defined or designated, it is determined when the threshold is met (S340). If so, a filtered or grouped set of items meeting the threshold are provided or displayed to the user (S350). Otherwise, an alternate presentation (e.g., an error message or not found notification) may be provided (S360).

In practice, the quality and outcome of the confidence assessment in different ratings or reviews may be more reliable when there is a high level of access to a relatively large database of information gathered across a relatively long span of time. Some providers or vendors may not have access to sufficiently large volumes of data (e.g., due to being new in the market, or due to a product not having a long sales history with the particular provider).

According to certain aspects, providers that are interested in providing a user with higher levels of accuracy in rating or review, may elect to receive confidence ratings that are determined based on a pooled array of databases that include relevant information about reviews and sales of the same or similar items. In this manner, a smaller provider may be able to benefit from confidence ratings associated with items reviewed or offered by providers that have higher volumes of products or reviews of products being offered for selection or items that have longer historic market longevity. Thus, providers that are able to collect or access relevant data about an item's reviews, ratings and factors associated with the reviewers authenticity, may in addition provide further details that notify a user with a confidence level or confidence score for the provided reviews or ratings.

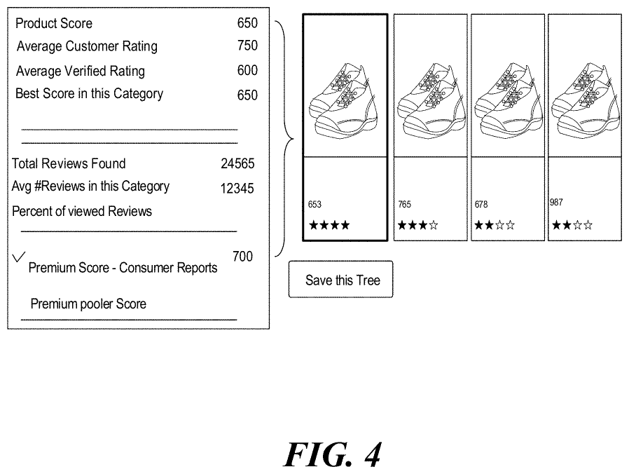

Referring to FIG. 4, examples of scores or data provided to a user or a consumer may include one or more of the following:
rating (e.g., a score or a number of stars calculated based on applying a formula, such as a mean or an average of all ratings),
confidence score (e.g., a value indicating trust level in the ratings or reviews),
highest score,
lowest score,
highest score for items in the same category,
total number of reviews,
total number of reviews meeting a threshold confidence level,
average number of reviews for a category to which the item belongs, and
percentage of verified reviews.

In one implementation, rating data collected by a reliable third party (e.g., Consumer Reports®) may be utilized in addition, instead or in combination with rating data collected or other data accessible by the provider. In this implementation, a selective score (e.g., a premium score) may be calculated or provided for an item based on the assumption that, for example, third party data is more reliable than the data collected by the provider itself, because the third party may have checks and balances in place that would ensure a higher level of confidence in rating data gathered by the third party, in comparison to data gathered by the provider based on public ratings and reviews that are generally unverified or difficult to verify.

Thus, depending on implementation, a score calculated based on public reviews or ratings may be provided in addition to an independent third party rating, or the calculated score may be combined with the independent third party rating to provide a combined rating. In accordance with one or more embodiments, the long-term collection and analysis of selection, sales or consumer data in combination with product ratings and the associated confidence levels may be leveraged into building user profiles that may be utilized to provide more relevant suggestions to a user and increase revenues for a provider in due course.

For example, after a user has viewed or selected a target item, or based on a user's navigation or viewing of the ratings of a target item, data collected from the user's behavior (e.g., before, during, and after the point of selection) may provide hints as to when the user may be ready to select or purchase the same item or a related item in the future. For example, if it is determined that the user viewed ratings for or purchased or selected a running shoe, then the same user may be provided with an opportunity to select or purchase the same or similar shoe sometime later (e.g., six month after the initial selection or purchase), depending on the running shoe's average life span, for example.

Furthermore, user's behavior may be profiled at the time of selection by monitoring the decision factors (e.g., depending on whether such decision factors define decision paths or decision trees) that are important or expressly requested by a user. These recordable behavior and preferences may be utilized or monetized by sellers, vendors or other service providers to help provide a user or consumer with more customized advertising and resulting in higher revenues for the provider.

In accordance with a commercial implementation, a scoring model may be implemented that is based on the data found in the reviews of products of a plurality of commercial websites. Such score may utilize characteristics of the reviews of a product to produce a score that indicates the likelihood that a user may trust the reviews shown for that product. The model will weigh multiple factors of the product reviews metadata (e.g., verified purchase, geo location of source, frequency of source across pooled models, distribution of ratings relative to other products in the class, etc.). In addition, through machine learning methods, a natural language analysis of the content of the written portion of the reviews may be created to build a mathematical model that may reliably predict the likelihood of the authenticity of reviews and provide a score summarizing the result using these characteristics.

As such, multiple decisions during a product selection process may be monitored and in view of publically posted ratings or reviews for a target item, a mathematical model may be trained and developed to generate confidence or trust scores or notifications based on the model's utilization of a large base of review data available from various e-commerce sites, for example. The resulting score may allow for product evaluation to be based on statistically accurate information that may support an evaluation by comparing the generated scores across similar products. In addition, as noted earlier, pooled models of data may be built overtime to span multiple major e-commerce sites. Data from such sites may be collected (e.g., under a contractual agreement or license) to develop and train pooled data models using neural networks, for example.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

What is claimed is:

1. A computer-implemented method comprising:
obtaining information associated with one or more items available for selection via user interaction with a user interface of a computing device operating in a computing environment, wherein the computing environment provides access to resources that store information about at least one characteristic of the one or more items, wherein the at least one characteristic is measurable;
determining a trust level for the at least one characteristic of a first item based on one or more computerized processes that evaluate values associated with the at least one characteristic across a set of values provided by users who considered at least one of the first item or a second item, wherein the first item and the second item are associable according to a common category; and
conspicuously presenting a sensory output in the user interface, wherein the sensory output represents the trust level for the at least one characteristic of the first item in a manner that distinguishes the first item from other items that are associable with the first item in the common category, to advantageously assist a user with selecting the first item,
the first item being selectable over the second item, in response to a user determining that the trust level associated with the at least one characteristic of the first item is more desirable.

2. The computer-implemented method of claim 1, wherein the at least one characteristic is related to a rating provided by one or more users during a time prior to the selection.

3. The computer-implemented method of claim 1, wherein the at least one characteristic is related to a review provided by one or more users during a time prior to the selection.

4. The computer-implemented method of claim 1, wherein the common category with which the first item and the second item are associated defines a type of product offered for sale.

5. The computer-implemented method of claim 1, wherein the common category with which the first item and the second item are associated defines a type of service offered for subscription.

6. The computer-implemented method of claim 1, wherein the first item and the second item are different instances of at least one of a product offered for sale or a service offered for subscription.

7. The computer-implemented method of claim 1, wherein the sensory output is at least one of a numeric value, a mnemonic, a color-indication, a visual chart, or a graph that provides a user with a comparative result that inspires a confidence level in the user as to whether to select the first item over another item from the one or more items available for selection.

8. The computer-implemented method of claim 1, further comprising grouping a set of items from the one or more items based on the trust level associated with said set of items meeting a common threshold or defined range.

9. The computer-implemented method of claim 1, further comprising aggregating the evaluated values associated with the at least one characteristic from across multiple providers presenting the first item for selection, such that an individual provider with limited access to the evaluated values based on a high selection volume determines a trust level for the at least one characteristic of the first item presented for selection by the individual provider.

10. The computer-implemented method of claim 9, further storing digital representations of a user's decision path in selecting one or more items based on determined trust levels associated with said one or more items and using the stored digital representations to provide offers to the user according to an analytical deduction taking into consideration the stored digital representations.

11. A computer-implemented system comprising:
at least one programmable processor; and
a non-transitory machine-readable medium storing instructions that, when executed by the at least one programmable processor, cause the at least one programmable processor to perform operations comprising:
obtaining information associated with one or more items available for selection via user interaction with a graphical user interface of a computing device operating in a computing environment, wherein the computing environment provides access to resources that store information about at least one characteristic of the one or more items, wherein the at least one characteristic is measurable;
determining a trust level for the at least one characteristic of a first item based on one or more computerized processes that evaluate values associated with the at least one characteristic across a set of values provided by users who considered at least one of the first item or a second item, wherein the first item and the second item are associable according to a common category; and
conspicuously presenting a graphical object in the graphical user interface, wherein the graphical object represents the trust level for the at least one characteristic of the first item in a manner that distinguishes the first item from other items that are associable with the first item in the common category, to advantageously assist a user with selecting the first item,
the first item being selectable over the second item, in response to a user determining that the trust level associated with the at least one characteristic of the first item is more desirable.

12. The computer-implemented system of claim 11, wherein the at least one characteristic is related to a rating provided by one or more users during a time prior to the selection.

13. The computer-implemented system of claim 11, wherein the at least one characteristic is related to a review provided by one or more users during a time prior to the selection.

14. The computer-implemented system of claim 11, further comprising aggregating the evaluated values associated with the at least one characteristic from across multiple vendors presenting the first item for selection, such that an individual vendor with limited access to the evaluated values based on a high selection volume determines a trust level for the at least one characteristic of the first item presented for selection by the individual vendor.

15. The computer-implemented system of claim 14, further storing digital representations of a user's decision path in selecting one or more items based on determined trust levels associated with said one or more items and using the stored digital representations to provide offers to the user according to an analytical deduction taking into consideration the stored digital representations.

16. A computer program product comprising a non-transitory machine-readable medium storing instructions that, when executed by at least one programmable processor, cause the at least one programmable processor to perform operations comprising:
obtaining information associated with one or more items available for selection via user interaction with a graphical user interface of a computing device operating in a computing environment, wherein the computing environment provides access to resources that store information about at least one characteristic of the one or more items, wherein the at least one characteristic is measurable;
determining a trust level for the at least one characteristic of a first item based on one or more computerized processes that evaluate values associated with the at least one characteristic across a set of values provided by users who considered at least one of the first item or a second item, wherein the first item and the second item are associable according to a common category; and
conspicuously presenting a graphical object in the graphical user interface, wherein the graphical object represents the trust level for the at least one characteristic of the first item in a manner that distinguishes the first item from other items that are associable with the first item in the common category, to advantageously assist a user with selecting the first item,
the first item being selectable over the second item, in response to a user determining that the trust level associated with the at least one characteristic of the first item is more desirable.

17. The computer program product of claim 16, wherein the at least one characteristic is related to a rating provided by one or more users during a time prior to the selection.

18. The computer program product of claim 16, wherein the at least one characteristic is related to a review provided by one or more users during a time prior to the selection.

19. The computer program product of claim 16, wherein the common category with which the first item and the second item are associated defines a type of product offered for sale.

20. The computer program product of claim 16, wherein the graphical object is at least one of a numeric value, a mnemonic, a color-indication, a visual chart, or a graph that provides a user with a comparative result that inspires a confidence level in the user as to whether to purchase the first item over another item from the one or more items available for selection.
